(19) United States
(12) Patent Application Publication
(10) Pub. No.: US 2006/0045740 A1
(43) Pub. Date: Mar. 2, 2006

(54) Swaying device for an electric fan

(76) Inventor: Chuan-Pan Huang, Tainan City (TW)

Correspondence Address: CHUAN-PAN HUANG;9F3R, NO. 210, Chunghsueh Rd., P.O. BOX 2-10, TAINAN CITY, TW

(21) Appl. No.: 10/894,145

(22) Filed: Jul. 20, 2004

(51) Int. Cl. B64C 11/30

(52) U.S. Cl. 416/61

(57) ABSTRACT

A swaying device for an electric fan includes a base consisting of an upper shell and a lower shell, a small motor and a detective element arranged in the base. The motor turns 360 degrees or sways for a certain angle adjustable to move the upper shell in the same way to turn or sway an electric fan fixed on the upper shell in the same way of the upper shell. The detecting element finds out the swaying angle of the electric fan and the speed of the swaying.

### FIELD OF THE INVENTION

The invention relates to a swaying device for an electric fan, particularly having a small motor arranged in a base to specifically move an upper shell of a base to turn 360 degrees or sway for a certain angle so an electric fan fixed on the upper shell may turn or sway in the same certain angle at the same time, and a detective element for finding out the swaying angle and the speed of the swaying.

### BACKGROUND OF THE INVENTION

A conventional swaying device for an electric fan shown in FIGS. 1, 2, 3 and 4 includes a speed reducer (A), a plurality of gears (A0) engaging with the speed reducer (A) one another. The rotation of the gears (A0) are controlled by a synchronous stator (B), which has no brush and a coil (B3), which is electrically powered to generates a magnetic field for rotating a rotor (B0), The rotor (B0) has a spindle (B1) connected with a gear (B2) engaging with the gear (A0) of the speed reducer (A) for the fan head (that is the fan together the motor and related components) to sway for a certain angle back and forth. However, The synchronous stator has no brush, so the rotating direction of the rotor (B0) and the magnetic field are not constant. Therefore, the swaying of the fan head is impossible to be smoothly controlled. In other words, the fan head is liable to be moved reversely by an exterior force. So a cooling fan available on the market as shown in FIG. 3 may have its fan C easily reversely sway by tough of a finger or something else. On this ground, a traditional electric fan may be provided with a control rod (D) shown in FIG. 4 for enforcing the fan head to sway in the correct swaying angle.

Moreover, the swaying angle controlled by the control rod (D) of the traditional electric fan is set constant, impossible to adjust, in the value of 30-45 degrees rightward and leftward.

### SUMMARY OF THE INVENTION

The invention has been devised to offer a swaying device for an electric fan, possible to force the electric fan to turn for 360 degrees or sway for a certain angle adjustable and its swaying angle and speed is accurately detectable.

The feature of the invention is described as follows.

1. The swaying device for an electric fan in the invention has a base and a small motor arranged in the base for turning for 360 degrees or swaying for a certain angle adjustable an electric fan fixed on an upper shell of the base and at the same time, and the swaying angle and speed can be detected by a detecting element in the base.

2. The detecting element in the base is a magnetic component or a Hall IC.

3. The detecting element in the base may be a light sensing component or an infrared sensing component.

### BRIEF DESCRIPTION OF DRAWINGS

This invention will be better understood by referring to the accompanying drawings, wherein:

FIG. 1 is a front view of a conventional speed reducer used in an electric fan;

FIG. 2 is a cross-sectional view of FIG. 1;

FIG. 3 is a front view of a conventional cooling fan;

FIG. 4 is a side view of a conventional electric fan;

FIG. 5 is an exploded perspective view of a first embodiment of a swaying device for an electric fan in the present invention;

FIG. 6 is a cross-sectional view of the first embodiment of a swaying device for an electric fan in the present invention;

FIG. 7 is a magnified view of the part marked (A) in FIG. 6;

FIG. 8 is a side cross-sectional view of a second embodiment of a swaying device for an electric fan in the present invention; and,

FIG. 9 is a magnified view of the part marked (B) in FIG. 8.

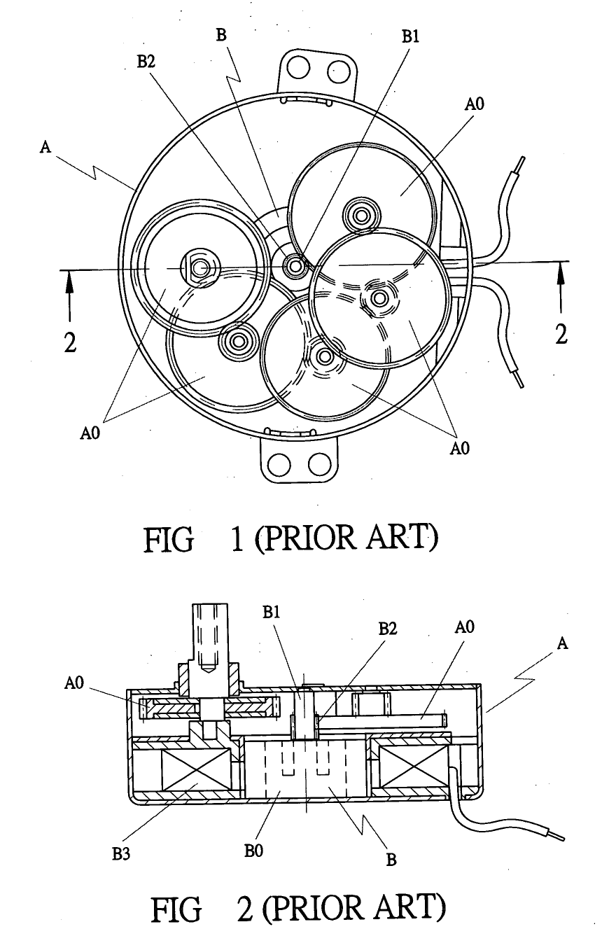

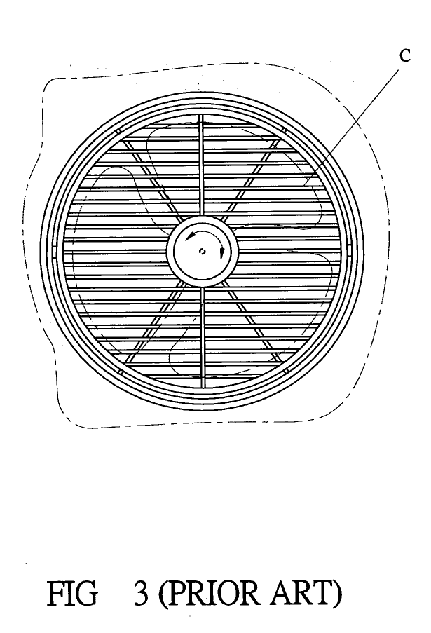

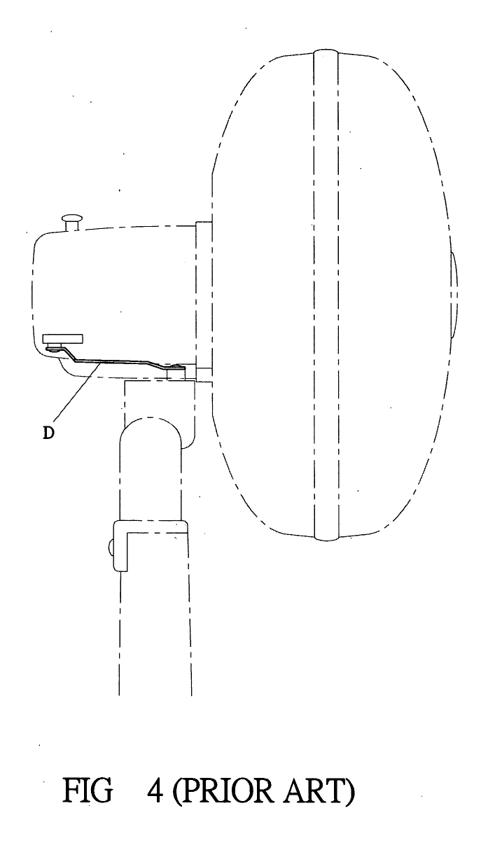

### DETAILED DESCRIPTION OF THE PREFERRED EMBODIMENT

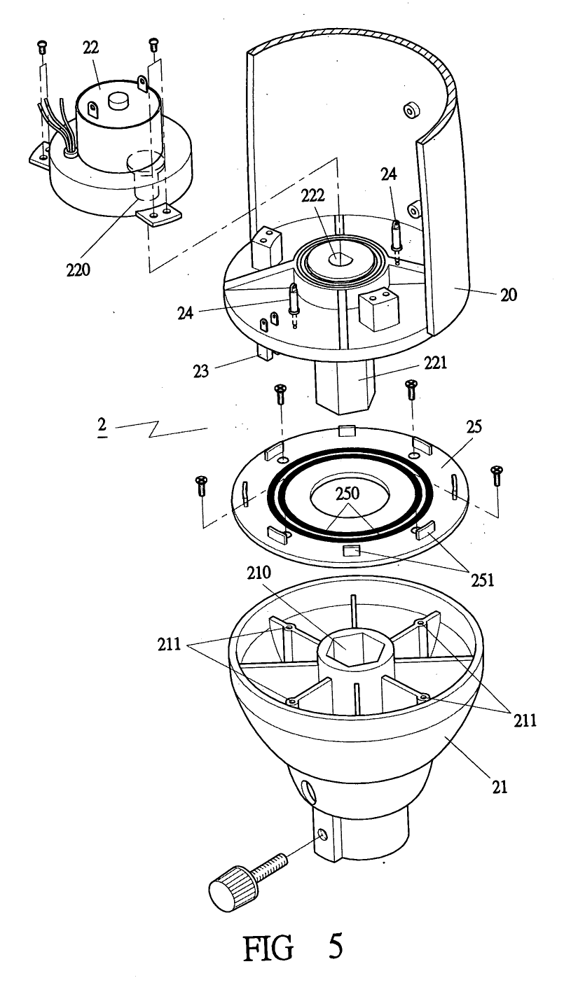

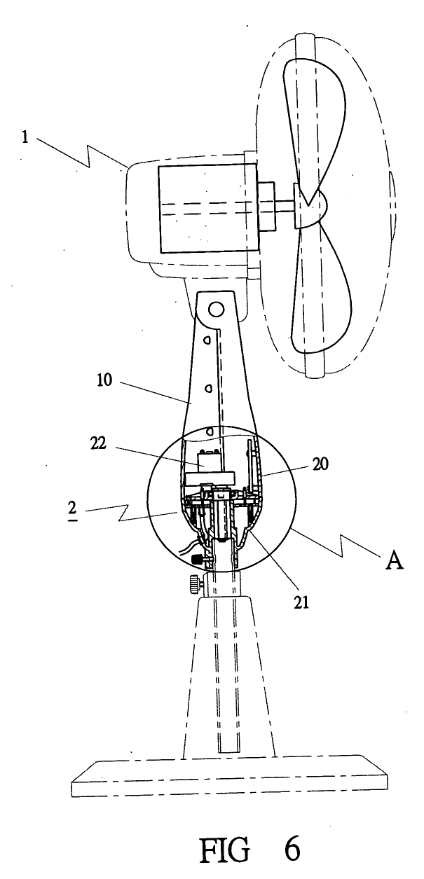

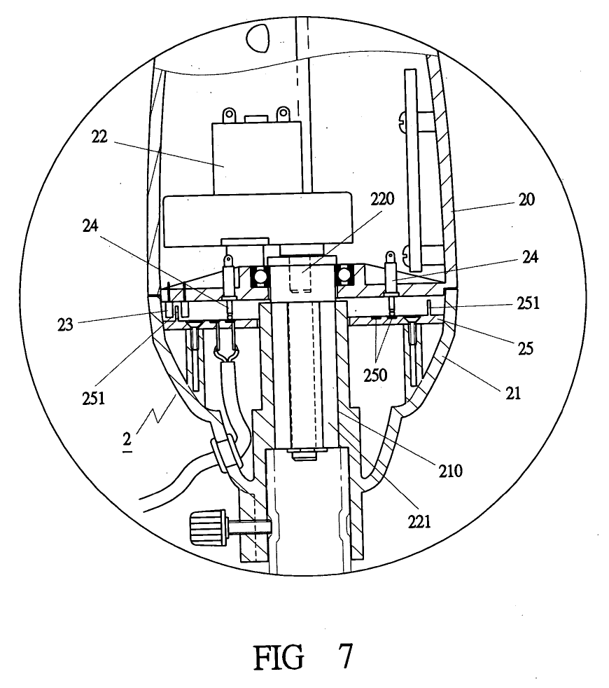

A first embodiment of a swaying device for an electric fan is to be fixed at any location of a housing 10 of an electric fan, including, as shown in FIGS. 5, 6 and 7, a base 2, a small motor 22, a light detecting element 23 and two conductors 24 and a disk 25 as main components.

The base 2 consists of an upper shell 20 of preferably a cylindrical shape and a lower shell 21 of a similar shape as the upper shell 20.

The small motor 22 is arranged stably in the base 2 on the upper shell 20, having an eccentric rod 220 positioned eccentrically on a lower surface of the motor housing and extending in a rod hole 222 of a non-circular shaft 221 (shown as hexagonal in the Figures), which extends down from the bottom surface of the upper shell 20. The non-circular shaft 221 also extends immovably in a non-circular shaft hole 210 of the lower shell 21. So when the motor 22 is powered, the eccentric rod 220 cannot rotate, because it is fixed with the con-circular shaft 221 fitted immovably in the non-circular hole 210 of the lower shell 21. Therefore, the whole motor 22 is forced to turn around its spindle and also forcing the upper shell 20 to turn at the same time, with its spindle stopped rotating. Thus, an electric fan fixed on the upper shell 20 may wholly turn for 360 degrees or sway for a certain angle adjustable back and forth together with the upper shell 20, controlled by a separate device.

The light-detecting element 23 is fixed under the bottom surface of the upper shell 20, and two conductors 24 are fixed on the upper bottom surface of the upper shell 20.

The lower shell 21 is provided with the non-circular hole 210 for the non-circular shaft 221 to fit therein and plural holes 211 for fixing a disk 25 on the lower shell 21 and under the upper shell 20.

The disk 25 fixed immovable on the lower shell 21 is provided with two annular conductive rings 250 spaced apart with an annular gap on an upper surface, but semicircular curves can also be used instead of the annular rings 250. The conductive rings 250 contact with the two conductors 24 for supplying the motor 22 with electric power. Further, a plurality of stop members 251 for the light detective element 23 to react for detecting the swaying angle and its speed. A separate device not covered in this invention adjusts the turning for 360 degrees or swaying for a certain angle of the small motor 22.

Next, when the motor 22 turns for 360 degrees or sways for a certain angle, it moves the upper shell 20 in the same way, so an electric fan fixed on the upper shell 20 of the base 2 also turns or sways in the same way as the small motor 22. Moreover, the light-detecting element 23 may face in turning or swaying one of the stop members 251 for the light-detecting element 23 to react and operate to sense the swaying angle and its speed of the electric fan. The light detecting element 23 can also be positioned on the disk 25, with the stop members 25 fixed on the upper shell 20, obtaining the same function as the way just described.

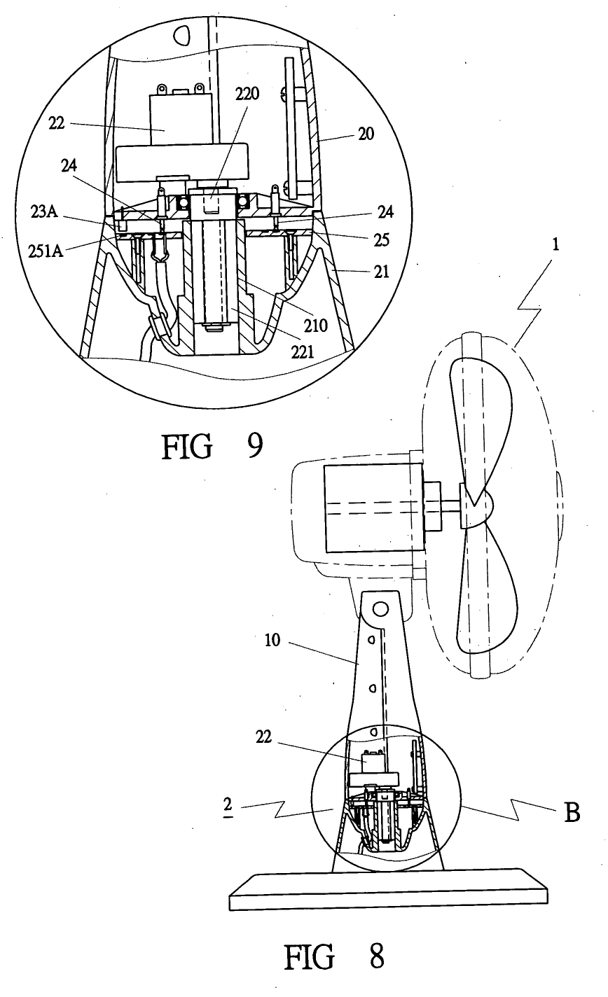

Further, FIGS. 8 and 9 shows a second embodiment of a swaying device for an electric fan in the invention, in which a Hall IC 23A is used as a detecting element, and plural magnetic elements 251A is fixed on the disk 25. Then the Hall IC 23A reacts with one of the magnetic elements 251A to find out the swaying angle of the electric fan swayed by the upper shell 20, which is swayed by the motor 22.

While the preferred embodiments of the invention have been described above, it will be recognized and understood that various modifications may be made therein and the appended claims are intended to cover all such modifications that may fall within the spirit and scope of the invention.

What is claimed is:

1. A swaying device for an electric fan comprising:
a base consisting of an upper shell and a lower shell, said upper shell having a bottom wall and a vertical annular wall, a non-circular shaft provided to extend down from a lower surface of the bottom wall of said upper shell, a rod hole formed in said non-circular shaft; said lower shell having a con-circular hole formed in the center vertical portion for said con-circular shaft of said upper shell to fit immovably therein:
a small motor fixed on the bottom of said upper shell to turn or sway together with said motor, and an eccentric rod fixed eccentrically under a bottom surface of said motor and extending down to fit in said rod hole of said non-circular shaft of said upper shell, said motor turning around for 360 degrees or swaying for a certain angle adjustable back and forth with its spindle as a shaft when electrically powered so that said upper shell may also turn around for 360 degrees or swaying for a certain angle back and forth to result in that an electric fan fixed on said upper shell of said base may also turn around for 360 degrees or sway for a certain angle back and forth together with said upper shell of said base: and,
a detecting element fixed under the bottom of said upper shell of said base for detecting the swaying angle of the electric fan fixed on said upper shell of said base.

1. The swaying device for an electric fan as claimed in claim 1, wherein said detecting element is a light detecting one.

2. The swaying device for an electric fan as claimed in claim 1, wherein said detecting element is a Hall IC, which reacts with one of the plural magnetic members for sensing the swaying angle of the electric fan.
